(19) United States
(12) Patent Application Publication
(10) Pub. No.: US 2016/0133375 A1
(43) Pub. Date: May 12, 2016

(54) COUPLING ON-DIE INDUCTORS FOR RADIO-FREQUENCY APPLICATIONS

(71) Applicant: Morfis Semiconductor, Inc., Irvine, CA (US)

(72) Inventors: Haitao Li, Irvine, CA (US); Sifen Luo, Irvine, CA (US); Changli Chen, Irvine, CA (US)

(21) Appl. No.: 14/934,015

(22) Filed: Nov. 5, 2015

Related U.S. Application Data
(60) Provisional application No. 62/076,416, filed on Nov. 6, 2014.

(51) Int. Cl. H01F 27/28

(52) U.S. Cl. CPC H01F 27/2804

(57) ABSTRACT

A circuit includes a dielectric layer, a first via residing in the dielectric layer, a second via residing in the dielectric layer, and an inductor. The inductor includes a first inductor element and a second inductor element. The first inductor element is formed by a first transmission line including a plurality of segments defined between a first end and a second end thereof. The second inductor element is formed by a second transmission line including a plurality of segments defined between a first end and a second end thereof. A first port is defined by one segment of the plurality of segments of the second transmission line, wherein current flows in the inductor in the same direction from a second port defined at the first end of the first transmission line to the first port, and from the first port to a third port defined at the second via.

### CROSS-REFERENCE TO RELATED APPLICATIONS

This application relates to and claims the benefit of U.S. Provisional Application No. 62/076,416, filed Nov. 6, 2014 and entitled “COUPLING ON-DIE INDUCTORS FOR RF POWER AMPLIFIER” the entirety of the disclosure of which is wholly incorporated by reference herein.

### STATEMENT RE: FEDERALLY SPONSORED RESEARCH/DEVELOPMENT

Not Applicable

### BACKGROUND

1. Technical Field

The present disclosure generally relates to the field of electronics. More particularly, the present disclosure relates to coupling on-die inductors for radio-frequency (RF) applications.

2. Related Art

An integrated circuit (IC) consists of an interconnected array of active and/or passive components integrated with a single semiconductor substrate or deposited on the substrate by a series of sequential processes, and capable of performing at least one electronic circuit function. Examples of active components are transistors, such as field-effect transistors, bipolar junction transistors, and diodes. Passive elements typically include inductors, capacitors, resistors, and, for high frequencies, transmission lines.

A circuit designer can design a functional circuit block by combining active and/or passive components in a specified configuration. In turn, the circuit designer can combine various functional circuit blocks into more complex circuits. The advancement of the design and manufacture of functional circuitry has resulted in functional circuitry with increased operating frequencies. For example, as the sizes of ICs have been scaled down, the operating frequencies of ICs have increased. High-frequency or RF inductors are one of the key elements for signal processing, particularly in RF analog circuits, such as filters, impedance-matching circuits, amplifiers and transformers.

In the field of telecommunications, for example, inductors are used in many ICs intended for RF applications. For example, on-chip inductors with high Quality factor (Q factor) are widely used in voltage controlled oscillators, low noise amplifiers and other RF building blocks. Inductors are utilized in military, aerospace and defense RF applications. For example, inductors have utility in communication, guidance and security applications, as well as in radar, test and evaluation, and other applications.

RF inductors can occupy a large portion of the available semiconductor real estate and, therefore, it is desirable to achieve the maximum possible level of compactness and efficiency in their design and fabrication. Highly integrated circuit designs achieve the benefits of smaller circuit size, improved circuit matching, precise control of component layout, and the availability of multiple active components within a small design package.

Inductor elements in RF integrated circuits (RFICs) are commonly made of flat or planar loops fabricated through conventional lithographic processes. Planar inductors with a structure having a spiral or meander planar coil can achieve small inductance values. A planar spiral configuration is printed on one side of a substrate and can provide various values of inductance depending upon the geometry of the convoluted spiral. However, the use of such planar patterns itself is often limited by two-dimensional space limitations.

For certain designs, two physically separated inductors are connected to a direct current (DC) voltage source. These two separated inductors may be DC connected at one end, and on the other end, each is connected to other circuits. This configuration basically forms a three-port network. It would be desirable to provide a structure that achieves a maximum of mutual inductance between two inductors to realize a three-port network that reduces RFIC die area and reduces cost.

RFICs are currently being utilized across a broad range of industries, e.g., aerospace, military, telecom, test & measurement, and medical electronics industries, and have utility in many applications. There is a continuing need in the art for improved inductor elements in RFICs.

### BRIEF SUMMARY

The present disclosure is directed to coupling on-die inductors to realize a two inductor three-port network for use in a broad range of applications.

According to an aspect of the present disclosure, there is a circuit. The circuit includes a dielectric layer, a first via residing in the dielectric layer, a second via residing in the dielectric layer, and an inductor. The inductor includes a first inductor element and a second inductor element. The first inductor element is formed by a first transmission line including a plurality of segments defined between a first end and a second end thereof. The second inductor element is formed by a second transmission line including a plurality of segments defined between a first end and a second end thereof. The second transmission line is disposed on a second side of the dielectric layer and inductively coupled with the first transmission line through a portion of the dielectric layer. A first port is defined by one segment of the plurality of segments of the second transmission line, wherein current flows in the inductor in the same direction from a second port defined at the first end of the first transmission line to the first port, and from the first port to a third port defined at the second via.

According to another aspect of the present disclosure, there is circuit including a dielectric layer, a first via residing in the dielectric layer, a second via residing in the dielectric layer, and an inductor. The inductor includes a first inductor element and a second inductor element. The first inductor element is formed by a first transmission line including a plurality of segments defined between a first end and a second end of the first transmission line. The plurality of segments of the first transmission line form a first inductor coil defined by a single spiral. The second inductor element is formed by a second transmission line including a plurality of segments defined between a first end and a second end of the second transmission line. The plurality of segments of the second transmission line form a second inductor coil defined by two spirals. A first port is defined by one segment of the plurality of segments of the second transmission line, wherein current flows in the inductor in the same direction from a second port defined at the first end of the first transmission line to the first port, and from the first port to a third port defined at the second via.

### BRIEF DESCRIPTION OF THE DRAWINGS

Objects and features of the presently-disclosed inductor structure will become apparent to those of ordinary skill in the art when descriptions of various embodiments thereof are read with reference to the accompanying drawings, of which:

FIG. 1 is a plan view of a conventional inductor including two, separated, spiral inductor coils;

FIG. 2A is a plan view showing a structure of an inductor including two inductor elements in accordance with an embodiment of the present disclosure;

FIG. 2B is a plan view showing the first inductor element of the structure of FIG. 2A in accordance with an embodiment of the present disclosure;

FIG. 2C is a plan view showing the second inductor element of the structure of FIG. 2A in accordance with an embodiment of the present disclosure;

FIG. 3 is a top and side view showing the structure of FIG. 2A with a dielectric layer between the first and second inductor elements in accordance with an embodiment of the present disclosure;

FIG. 4 is a schematic illustration of a circuit in accordance with an embodiment of the present disclosure;

FIG. 5 is a plot illustrating inductance variation between the first port and the second port of the structure shown in FIG. 2A; and

FIG. 6 is a plot inductance variation between the first port and the third port of the structure shown in FIG. 2A in accordance with an embodiment of the present disclosure.

### DETAILED DESCRIPTION

Hereinafter, embodiments of an inductor structure are described with reference to the accompanying drawings Like reference numerals may refer to similar or identical elements throughout the description of the figures.

This description may use the phrases “in an embodiment,” “in embodiments,” “in some embodiments,” or “in other embodiments,” which may each refer to one or more of the same or different embodiments in accordance with the present disclosure.

As it is used herein, the term “spiral” is intended to encompass a broad class of structures which exhibit a clockwise or counterclockwise outwardly winding path, e.g., beginning in a substantially centralized location, in which each winding is successively longer than the previous winding. This definition is intended to embody generally rectangular, polygonal, oval, elliptical, and circular spirals as well as other irregular yet generally spiraling shapes. For illustrative purposes, generally polygonal spirals are shown in the figures. As it is used in this description, “printed circuit board” (or “PCB”) generally refers to any and all systems that provide, among other things, mechanical support to electrical components, electrical connection to and between these electrical components, combinations thereof, and the like. The “PCBs” and “circuit boards” described herein are not limited to electrical component-populated boards, but also include non-populated circuit traced substrates of all types, e.g., semiconductor integrated circuits, etc.

In RFICs design, spiral inductors can occupy a large die area. Various embodiments of the present disclosure provide an inductor structure including first and second inductor elements configured to realize a three-port network that reduces RFIC die area. The presently-disclosed inductor structures may be utilized in a wide range of applications, for example, commercial, military, aerospace, healthcare, and security applications. Embodiments of the presently-disclosed inductor structures may be suitable for use with a variety of circuits.

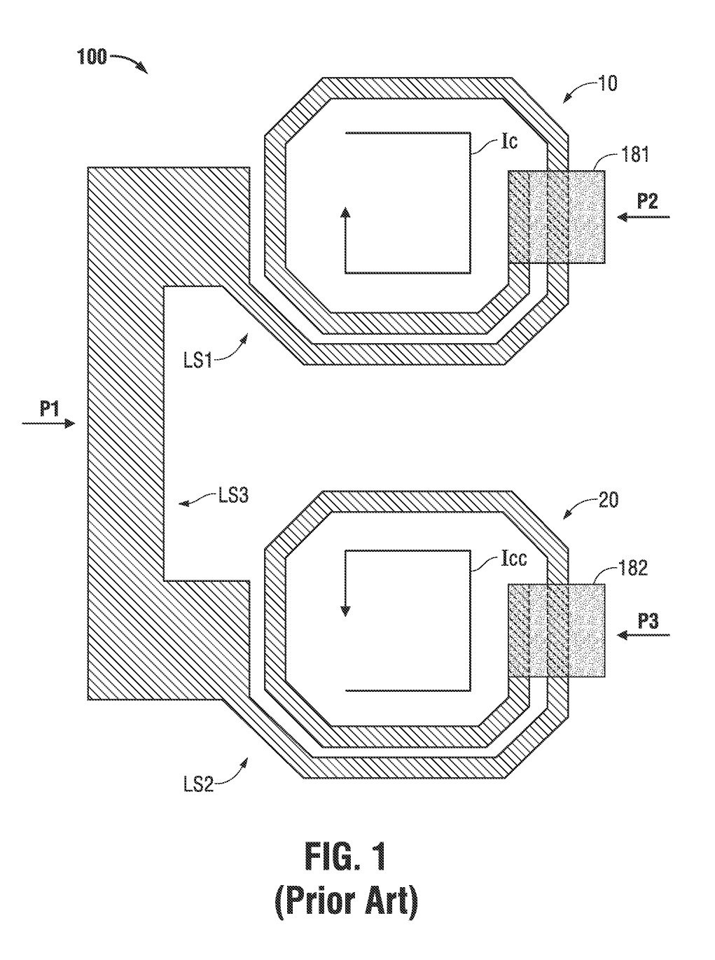

Referring now to FIG. 1, there is shown a conventional inductor 100 including a first inductor coil 10 and a second inductor coil 20 connected by a common node “P1” (also referred to herein as first port “P1”). The first inductor coil 10 is formed with only one layer of metal by a first line segment “LS1” and the second inductor coil 20 is formed with only one layer of metal by a second line segment “LS2.” The first line segment “LS1” and the second line segment “LS2” are connected by a third line segment “LS3.”

The first line segment “LS1” is electrically coupled to a first via 181. The second line segment “LS2” is electrically coupled to a second via 182. A first port “P1” is defined at the third line segment “LS3.” A second port “P2” is defined at the first via 181. A third port “P3” is defined at the second via 182. As depicted in FIG. 1, from second port “P2” to first port “P1,” the current “I_{c}” flows clockwise (as indicated by the arrowed rectilinear line) in the first inductor coil 10, and from first port “P1” to third port “P3,” the current “I_{cc}” flows counter clockwise (as indicated by the arrowed rectilinear line) in the second inductor coil 20.

It will be apparent to those of ordinary skill in the art that the first inductor coil 10 and the second inductor coil 20 can be laid out to have current flow clockwise in both of the spiral inductor coils, or can be laid out to have current flow clockwise in one of the spiral inductor coils and counter clockwise in the other inductor coil.

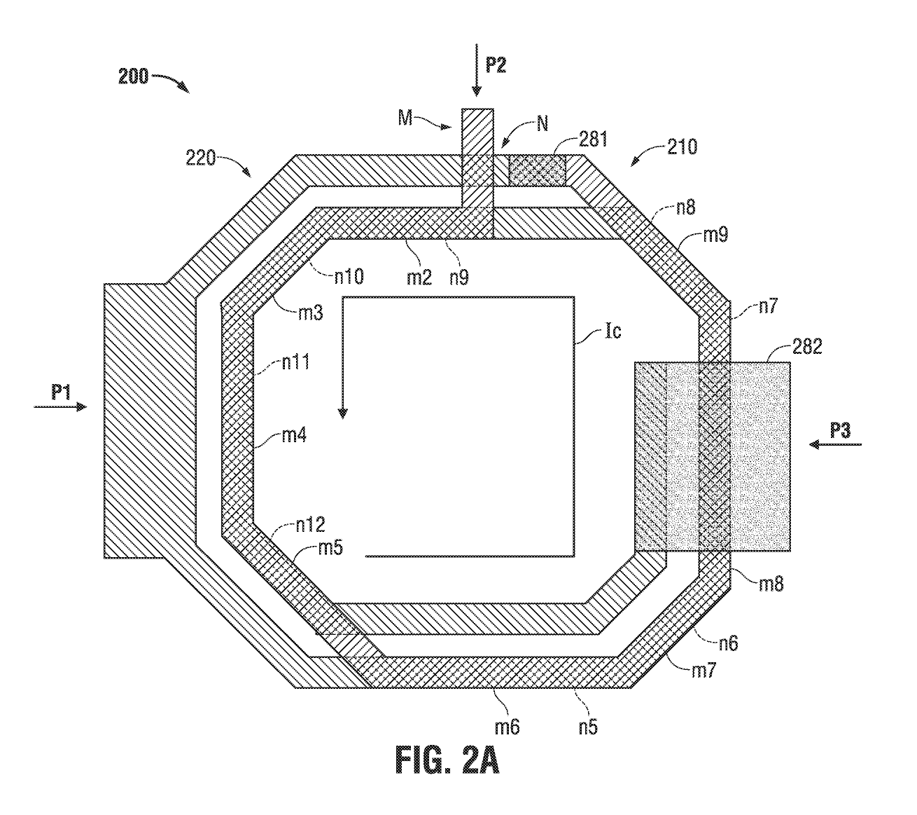

FIGS. 2A-2C show an inductor structure 200 including a first inductor element 210 and a second inductor element 220 in accordance with an embodiment of the present disclosure. The first inductor element 210 is formed by a first transmission line “M” having a plurality of segments (as shown in FIG. 2B), and the second inductor element 220 is formed by a second transmission line “N” having a plurality of segments (as shown in FIG. 2C). The first transmission line “M” and the second transmission line “N” may be separated by an air gap or other dielectric.

The first and second transmission lines “M” and “N” may include any suitable electrically-conductive material, e.g., a metal. In some embodiments, the first and second transmission lines “M” and “N” may include copper, gold, silver, or other conductive metals or metal alloys having similar conductivity values. In FIG. 2A, the dielectric layer between the first and second inductors 210 and 220 is omitted for ease of illustration and clarity.

In FIG. 2A, the second inductor element 220 is shown in vertical alignment with portions of the first inductor element 210. The structure 200 uses inductive coupling to combine the first and second inductors elements 210 and 220 and realize the same required inductance between a first port “P1” and a second port “P2” and between the first port “P1” and a third port “P3.” The key is to have current flowing in the same direction from the second port “P2” to the first port “P1” and from the first port “P1” to the third port “P3.” In some embodiments, as shown for example in FIG. 2A, the current “I_{c}” flows clockwise (as indicated by the arrowed rectilinear line). In other embodiments, the inductor structure 200 may be configured to have the current flow counter clockwise.

As shown in FIG. 2B, the plurality of segments of the first transmission line “M” form a first inductor coil defined by a single spiral. The first transmission line “M” includes a first segment “m1” (also referred to herein as the “first end” of the first transmission line), a second segment “m2,” a third segment “m3,” a fourth segment “m4,” a fifth segment “m5,” a sixth segment “m6,” a seventh segment “m7,” an eighth segment “m8,” a ninth segment “m9,” and a tenth segment “m10” (also referred to herein as the “second end” of the first transmission line). In the illustrative embodiment shown in FIG. 2B, the first inductor 210 has a polygonal spiral shape, e.g., partially defined by the second segment “m2” and the sixth segment “m6,” which are arranged in parallel and spaced apart from each other, and partially defined by the fourth segment “m4” and the eighth segment “m8,” which are arranged in parallel and spaced apart from each other (and arranged perpendicular to the second segment “m2” and the sixth segment “m6”).

As shown in FIG. 2C, the plurality of segments of the second transmission line “N” form a second inductor coil defined by two spirals. The second transmission line “N” includes a first segment “n1” (also referred to herein as the “first end” of the second transmission line) a second segment “n2,” a third segment “n3,” a fourth segment “n4,” a fifth segment “n5,” a sixth segment “n6,” a seventh segment “n7,” an eighth segment “n8,” a ninth segment “n9,” a tenth segment “n10,” an eleventh segment “n11,” a twelfth segment “n12,” a thirteenth segment “n13,” a fourteenth segment “n14,” and a fifteenth segment “n15” (also referred to herein as the “second end” of the second transmission line).

In some embodiments, at least a portion of each of the two spirals of the second inductor coil of the second transmission line “N” is vertically aligned with the first inductor coil of the first transmission line “M.” In some embodiments, as shown for example in FIG. 2A, the second, third, fourth and fifth segments “m2,” “m3,” “m4” and “m5” of the first transmission line “M” are vertically aligned with the ninth, tenth, eleventh and twelfth segments “n9,” “n10,” “n11” and “n12” of the second transmission line “N,” respectively, and the sixth, seventh, eighth and ninth segments “m6,” “m7,” “m8” and “m9” of the first transmission line “M” are vertically aligned with the fifth, sixth, seventh and eighth segments “n5,” “n6,” “n7” and “n8” of the second transmission line “N.”

In some embodiments, the tenth segment “m10” of the first transmission line “M” and the first segment “n1” of the second transmission line “N” are electrically coupled to a first via 281. In some embodiments, the tenth segment “m10” of the first transmission line “M” and the fifteenth segment “n15” of the second transmission line “N” is electrically coupled to a second via 282. It is to be understood that the first inductor element 210 and the second inductor element 220 may include any number of portions or segments. The first transmission line “M” forming the first inductor element 210 and the second transmission line “N” forming the second inductor element 220 may include straight line segments, curvilinear line segments, angular line segments, etc.

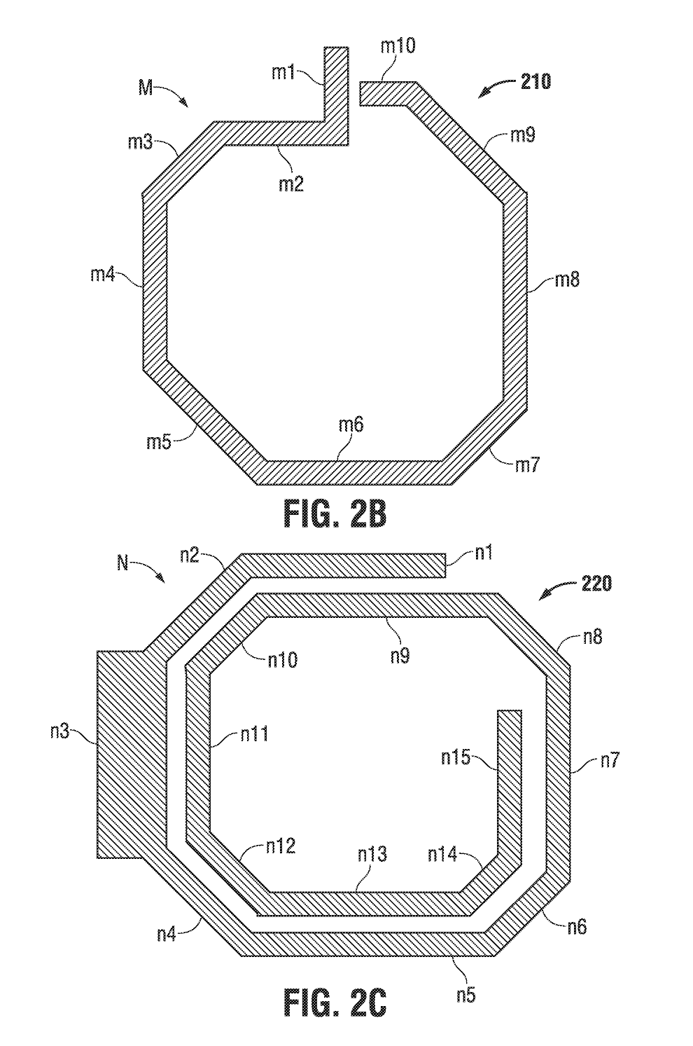

FIG. 3 shows a portion of a printed circuit board including the structure 200 shown in FIGS. 2A-2C in accordance with an embodiment of the present disclosure. The printed circuit board includes a substrate 12 having a first side “S1” (e.g., an upper side) and a second side “S2” (e.g., a lower side). The substrate 12 may be formed of any suitable dielectric material by any suitable process. The first transmission line “M” of the structure 200 is disposed on the first side “S1” of the dielectric layer 12. The second transmission line “N” of the structure 200 is disposed on the second side “S2” of the dielectric layer 12. As shown in FIG. 3, the first port “P1” is defined by the third segment “n3” of the second transmission line “N,” the second port “P2” is defined at the first end (first segment “m1”) of the first transmission line “M,” and the third port “P3” is defined at the second via 282.

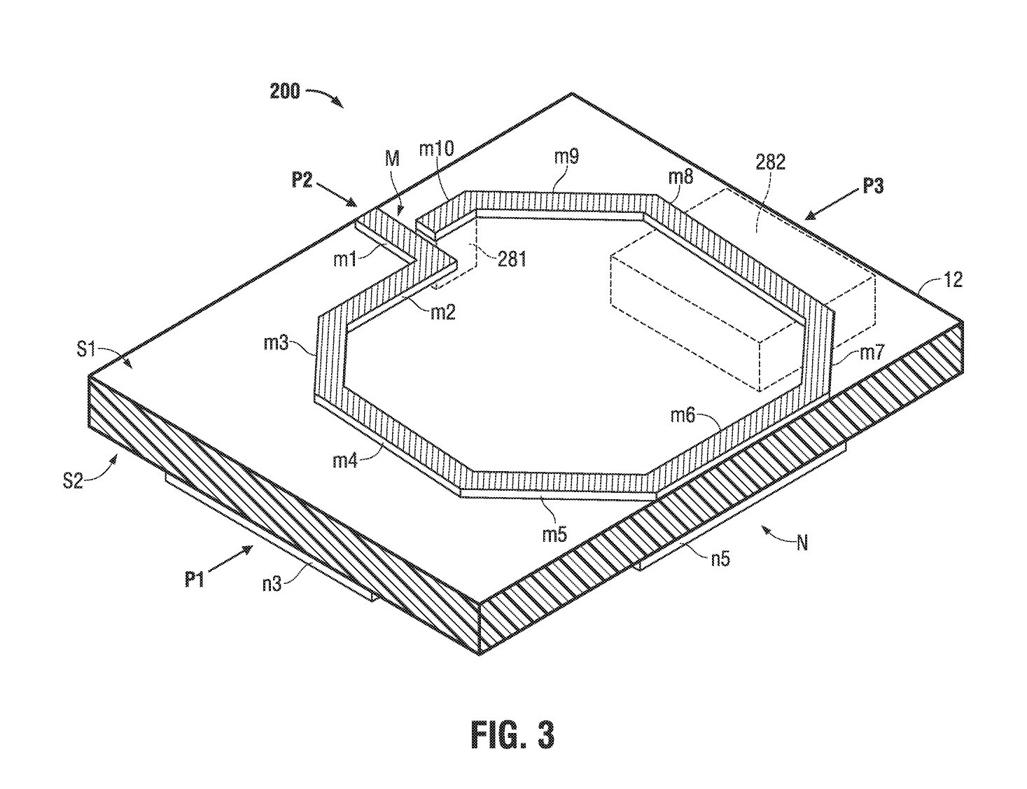

FIG. 4 shows a circuit 400 in accordance with an embodiment of the present disclosure. The circuit 300 includes a capacitor “C₁” coupled between a first terminal “T₁” and a second terminal “T₂.” The first terminal “T₁” is connected to the first port “P1” and the second terminal “T₂” is connected to the second port “P2.” For the simulation setup depicted in FIG. 4, the capacitor “C₁” has a capacitance of 50 picofarads (pF), the first terminal “T₁” has an impedance (Z) of 10 Ohms, and the second terminal “T₂” has an impedance (Z) of 33 Ohms. In the illustrated simulation setup, the capacitor “C₁” to ground is acting as a RF short for the third port “P3.”

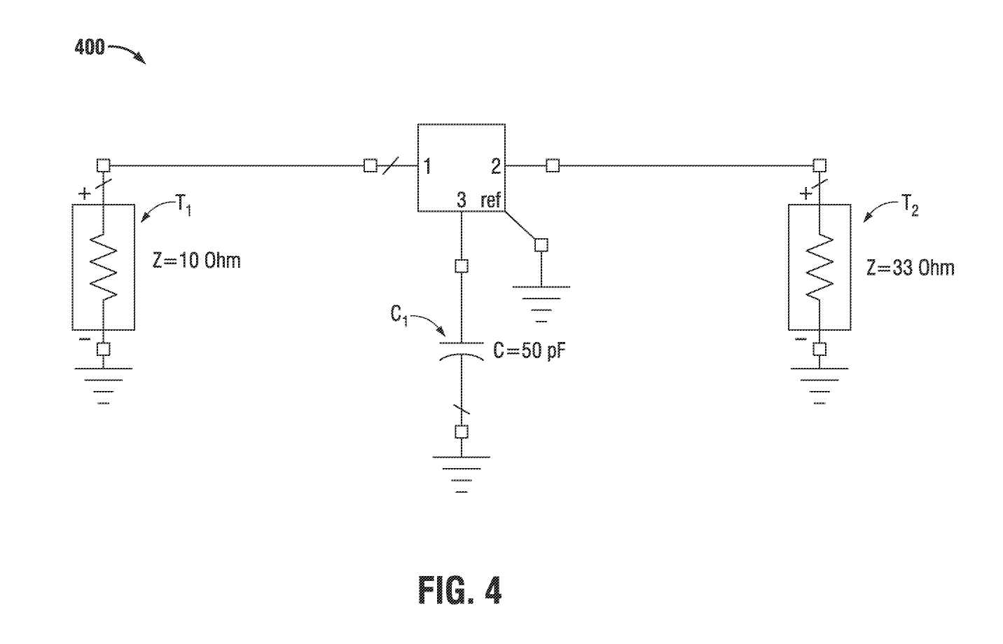

FIG. 5 shows a plot of frequency (GHz) versus inductance (nH) between the first port “P1” and a second port “P2” of the structure 100 shown in FIG. 1 (as indicated by the solid line in FIG. 5) and the structure 200 shown in FIG. 2A (as indicated by the dashed line in FIG. 5).

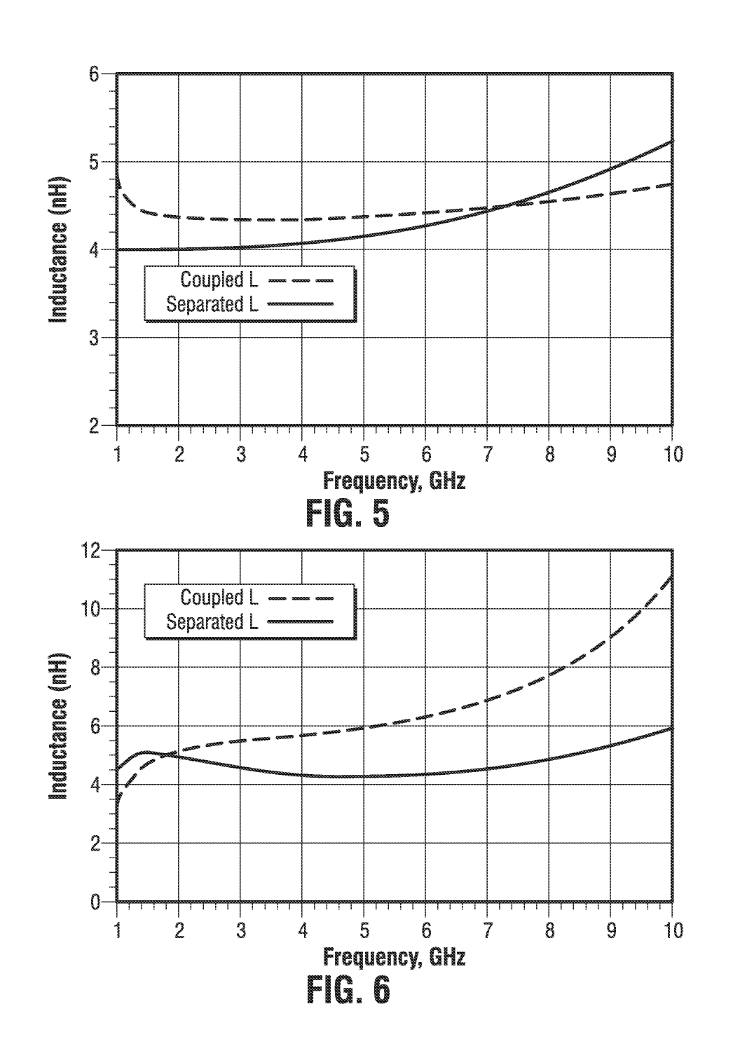

FIG. 6 shows a plot of frequency (GHz) versus inductance (nH) between the first port “P1” and a third port “P3” of the structure 100 shown in FIG. 1 (as indicated by the solid line in FIG. 6) and the structure 200 shown in FIG. 2A (as indicated by the dashed line in FIG. 6).

Although embodiments have been described in detail with reference to the accompanying drawings for the purpose of illustration and description, it is to be understood that the disclosed processes and apparatus are not to be construed as limited thereby. It will be apparent to those of ordinary skill in the art that various modifications to the foregoing embodiments may be made without departing from the scope of the disclosure. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A circuit, comprising:
a dielectric layer;
a first via residing in the dielectric layer;
a second via residing in the dielectric layer; and
an inductor, including:
a first inductor element formed by a first transmission line including a first end, a second end, and a plurality of segments defined between the first end and the second end of the first transmission line; and
a second inductor element formed by a second transmission line including a first end, a second end, and a plurality of segments defined between the first end and the second end of the second transmission line,
wherein one segment of the plurality of segments of the second transmission line defines a first port, and wherein current flows in the inductor in the same direction from a second port defined at the first end of the first transmission line to the first port, and from the first port to a third port defined at the second via.

2. The circuit of claim 1, wherein the plurality of segments of the first transmission line form a first inductor coil defined by a single spiral.

3. The circuit of claim 2, wherein the plurality of segments of the second transmission line form a second inductor coil defined by two spirals.

4. The circuit of claim 3, wherein at least a portion of each of the two spirals of the second inductor coil is vertically aligned with the first inductor coil.

5. The circuit of claim 1, wherein the first end of the second transmission line and the second end of the first transmission line are electrically coupled to the first via.

6. The circuit of claim 1, wherein the second end of the second transmission line is electrically coupled to the second via.

7. The circuit of claim 1, wherein the plurality of segments of the first transmission line includes a first segment, a second segment, a third segment, a fourth segment, a fifth segment, a sixth segment, a seventh segment, an eighth segment, a ninth segment, and a tenth segment.

8. The circuit of claim 7, wherein the second segment and the sixth segment of the first transmission line are arranged in parallel and spaced apart from each other, and wherein the fourth segment and the eighth segment of the first transmission line are arranged in parallel and spaced apart from each other.

9. The circuit of claim 1, wherein the second transmission line includes a first segment, a second segment, a third segment, a fourth segment, a fifth segment, a sixth segment, a seventh segment, an eighth segment, a ninth segment, a tenth segment, an eleventh segment, a twelfth segment, a thirteenth segment, a fourteenth segment, and a fifteenth segment.

10. The circuit of claim 9, wherein the first port is defined by the third segment of the second transmission line.

11. A circuit, comprising:
a dielectric layer;
a first via residing in the dielectric layer;
a second via residing in the dielectric layer; and
an inductor, including:
a first inductor element formed by a first transmission line including a plurality of segments defined between a first end and a second end of the first transmission line, wherein the plurality of segments of the first transmission line form a first inductor coil defined by a single spiral; and
a second inductor element formed by a second transmission line including a plurality of segments defined between a first end and a second end of the second transmission line, wherein the plurality of segments of the second transmission line form a second inductor coil defined by two spirals,
wherein one segment of the plurality of segments of the second transmission line defines a first port, and wherein current flows in the inductor in the same direction from a second port defined at the first end of the first transmission line to the first port, and from the first port to a third port defined at the second via.

12. The circuit of claim 11, wherein the second transmission line is disposed on a second side of the dielectric layer and inductively coupled with the first transmission line through a portion of the dielectric layer.

13. The circuit of claim 11, wherein the first end of the second transmission line and the second end of the first transmission line are electrically coupled to the first via, and wherein the second end of the second transmission line is electrically coupled to the second via.

14. The circuit of claim 11, wherein the plurality of segments of the first transmission line includes a first segment, a second segment, a third segment, a fourth segment, a fifth segment, a sixth segment, a seventh segment, an eighth segment, a ninth segment, and a tenth segment.

15. The circuit of claim 14, wherein the second segment and the sixth segment of the first transmission line are arranged in parallel and spaced apart from each other, and wherein the fourth segment and the eighth segment of the first transmission line are arranged in parallel and spaced apart from each other.

16. The circuit of claim 15, wherein the second transmission line includes a first segment, a second segment, a third segment, a fourth segment, a fifth segment, a sixth segment, a seventh segment, an eighth segment, a ninth segment, a tenth segment, an eleventh segment, a twelfth segment, a thirteenth segment, a fourteenth segment, and a fifteenth segment.

17. The circuit of claim 16, wherein the tenth segment of the first transmission line and the first segment of the second transmission line are electrically coupled to the first via.
